(19) United States
(12) Patent Application Publication
(10) Pub. No.: US 2021/0166302 A1
(43) Pub. Date: Jun. 3, 2021

(54) VEHICLE RENTAL ASSISTANCE DEVICE, INCENTIVE DETERMINATION METHOD, AND INCENTIVE DETERMINATION PROGRAM

(71) Applicant: TOYOTA JIDOSHA KABUSHIKI KAISHA, Aichi-ken (JP)

(72) Inventors: Yukinori II, Toyota-shi (JP); Takeo MORIAI, Nagakute-shi (JP); Kazunori MITOMI, Toyota-shi (JP); Yasuyuki KAMEZAKI, Toyota-shi (JP); Kenta MIYAHARA, Toyota-shi (JP)

(21) Appl. No.: 17/070,924

(22) Filed: Oct. 15, 2020

(30) Foreign Application Priority Data
Dec. 3, 2019 (JP) 2019-219095

(51) Int. Cl. G06Q 30/06; G06Q 30/02; G07C 5/08; G06T 7/00

(52) U.S. Cl. CPC G06Q 30/0645; G06T 7/001; G07C 5/0808; G06Q 30/0207

(57) ABSTRACT

A vehicle rental assistance device includes a memory and a processer connected to the memory, and the processor is configured to acquire vehicle condition information relating to at least one level of a level of decline in quality of appearance of a vehicle or a level of decline in cleanliness inside a cabin of the vehicle, and is configured to determine an incentive for vehicle rental according to the at least one level, based on the acquired vehicle condition information.

### CROSS-REFERENCE TO RELATED APPLICATION

This application claims priority under 35 USC 119 from Japanese Patent Application No. 2019-219095 filed Dec. 3, 2019, the disclosure of which is incorporated by reference herein in its entirety.

### BACKGROUND

### Technical Field

The present disclosure relates to a vehicle rental assistance device, an incentive determination method, and an incentive determination program.

### Related Art

International Publication (WO) 2016/132423 discloses technology to compute a vehicle rental charge. To explain briefly, in the related art, a travel route is identified using a travel history, and travel conditions are identified using the travel history and the travel route. The vehicle rental charge is then computed according to the travel conditions. The person who rented the vehicle is thereby able to pay a rental charge according to the usage conditions after use.

### SUMMARY

However, in the case of the related art, although the state of the vehicle after rental is taken into consideration, the condition of the vehicle prior to rental is not taken into consideration. Thus, in the case of the related art, a situation might arise in which, for example, vehicles with a relatively poor quality of appearance or vehicles with relatively poor cleanliness inside the vehicle cabin are rented out at the same charge as vehicles that are almost new, simply because the vehicles are in the same class.

Thus, for example, it is not possible to meet the needs of a user who desires an incentive such as a discount conferred according to the condition of the vehicle prior to rental.

In consideration of the above circumstances, the present disclosure obtains a vehicle rental assistance device, an incentive determination method, and an incentive determination program capable of meeting the needs of a user who desires an incentive conferred according to the condition of a vehicle prior to rental.

A vehicle rental assistance device of a first aspect of the present disclosure includes a memory and a processer connected the memory. The processer is configured to acquire vehicle condition information relating to at least one level of a level of decline in quality of appearance of a vehicle or a level of decline in cleanliness inside a cabin of the vehicle, and is configured to determine an incentive for vehicle rental according to the at least one level, based on the acquired vehicle condition information.

According to the above configuration, the processer acquires the vehicle condition information relating to the at least one level of the level of decline in the quality of appearance of the vehicle or the level of decline in the cleanliness inside the cabin of the vehicle. The processer then determines an incentive for vehicle rental according to the level, based on the acquired vehicle condition information. This enables the needs of a user who desires an incentive conferred according to the condition of a vehicle in a state prior to rental to be met.

A vehicle rental assistance device of a second aspect of the present disclosure is the configuration of the first aspect, wherein the vehicle condition information relating to the level of decline in cleanliness includes information relating to an odor level.

According to the above configuration, in cases in which the acquired vehicle condition information includes information relating to the level of decline in cleanliness, this information includes information relating to the odor level. In such cases, the incentive determined by the processer can be made to reflect the odor level.

A vehicle rental assistance device of a third aspect of the present disclosure is the configuration of the first aspect or the second aspect, wherein the processer determines an incentive based on the acquired vehicle condition information such that as the level for a vehicle gets higher a greater benefit is conferred on a user who rents the vehicle.

According to the above configuration, the needs of a user can be met with a comparatively simple configuration.

A vehicle rental assistance device of a fourth aspect of the present disclosure is the configuration of any one of the first aspect to the third aspect, wherein the processer computes and acquires the level of decline in the quality of appearance of each vehicle in a state prior to rental by comparing a reference image of a vehicle against a comparative image of the vehicle in the state prior to rental.

According to the above configuration, since the processer uses image comparison to compute and acquire the level of decline in the quality of appearance of each vehicle, the level of decline in the quality of appearance of the vehicles can be acquired with good precision.

A vehicle rental assistance device of a fifth aspect of the present disclosure is the configuration of any one of the first aspect to the fourth aspect, the processer is further configured to present the incentive offered with respect to a vehicle for rental. Note that “present the incentive” includes, for example, presenting a rental fee after a discount corresponding to the incentive has been deducted (the rental fee reflecting the reduced amount) in cases in which the incentive is a discount.

According to the above configuration, the processer of the vehicle rental assistance device presents the incentive offered with respect to a vehicle for rental. This enables a user wishing to rent a vehicle to ascertain the incentive from the presentation of the processer.

A vehicle rental assistance device of a sixth aspect of the present disclosure is the configuration of the fifth aspect, wherein the processer is further configured to present the at least one level representing the acquired vehicle condition information.

According to the above configuration, since the processer presents the at least one level representing the acquired vehicle condition information , a user wishing to rent a vehicle is able to ascertain the reason why the incentive is being conferred.

An incentive determination method of a seventh aspect of the present disclosure, the method is executed by a computer, and the incentive determination method includes: acquiring vehicle condition information relating to at least one level of a level of decline in quality of appearance of a vehicle or a level of decline in cleanliness inside a cabin of the vehicle, and determining an incentive for vehicle rental according to the at least one level, based on the acquired vehicle condition information. Similarly to the first aspect, this enables the needs of a user who desires an incentive conferred according to the condition of a vehicle in a state prior to rental to be met.

A non-transitory recording medium storing an incentive determination program of an eighth aspect of the present disclosure, the incentive determination program is executable by a computer to perform processing, the processing including: acquiring vehicle condition information relating to at least one level of a level of decline in quality of appearance of a vehicle or a level of decline in cleanliness inside a cabin of the vehicle, and determining an incentive for vehicle rental according to the at least one level, based on the acquired vehicle condition information. The incentive determination method of the seventh aspect is thus implemented by the computer as a result of the computer executing the incentive determination program according to the present aspect. Thus, similarly to the first aspect and the seventh aspect, this enables the needs of a user who desires an incentive conferred according to the condition of a vehicle in the state prior to rental to be met.

As described above, the present disclosure exhibits the excellent advantageous effect of being capable of meeting the needs of a user who desires an incentive conferred according to the condition of a vehicle in a state prior to rental.

### BRIEF DESCRIPTION OF THE DRAWINGS

Preferred embodiments will be described in detail based on the following figures, wherein:

FIG. 1 is a diagram schematically illustrating an overall configuration of a vehicle rental assistance system including a reservation server, according to an exemplary embodiment;

FIG. 2 is a block diagram illustrating an example of a hardware configuration of an onboard unit;

FIG. 3 is a block diagram illustrating an example of a hardware configuration of a reservation server;

FIG. 4 is a block diagram illustrating an example of a functional configuration of a reservation server;

FIG. 5 is a flowchart illustrating an example of a flow of incentive determination processing by a reservation server;

FIG. 6A is a diagram illustrating a simplified example of information acquired from an onboard unit;

FIG. 6B is a diagram illustrating a simplified example of computation results for a level of decline in the quality of appearance of a vehicle;

FIG. 6C illustrates an example of a vehicle type table;

FIG. 6D illustrates an example of a discount coefficient table;

FIG. 6E illustrates an example of a standard charge table;

FIG. 7A illustrates a simplified example of an image data table;

FIG. 7B illustrates an example of a discount data table; and

FIG. 8 illustrates an example of search results displayed on a user terminal.

### DETAILED DESCRIPTION

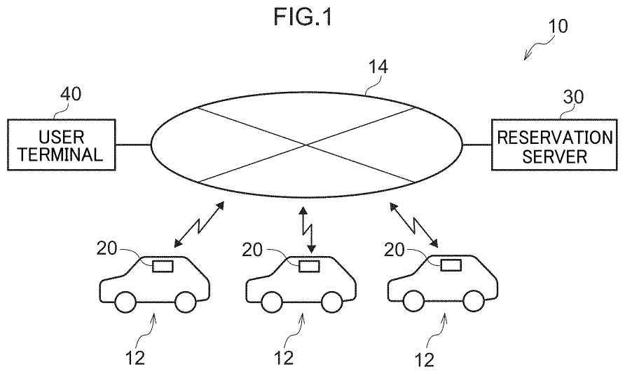

Explanation follows regarding a vehicle rental assistance device, an incentive determination method, and an incentive determination program according to an exemplary embodiment of the present disclosure, with reference to FIG. 1 to FIG. 8. FIG. 1 is a diagram schematically illustrating an overall configuration of a vehicle rental assist system 10 including a reservation server 30, serving as a vehicle rental assistance device according to the present exemplary embodiment.

As illustrated in FIG. 1, the vehicle rental assist system 10 is configured including onboard units 20 that are respectively installed in plural vehicles 12, the reservation server 30 belonging to a company that offers a rental service for the vehicles 12, and a user terminal 40 employed by a user. The onboard units 20, the reservation server 30, and the user terminal 40 are capable of communicating with each other through a communication network 14 such as the Internet.

The onboard units 20 of the respective vehicles 12 have a function of capturing images of an appearance of an interior and exterior of the respective vehicle 12 in which the onboard unit 20 is installed, and transmitting these captured images to the reservation server 30. The onboard unit 20 also has a function of detecting a strength of an odor inside the cabin of the vehicle 12 and transmitting the detection result to the reservation server 30. Specific configuration and operation of the onboard unit 20 are described in detail later.

The reservation server 30 executes predetermined processing relating to reservations, such as determining incentives (for example, discount amounts) to be applied to each of the vehicles 12 based on the images and odor strength as transmitted from the corresponding onboard unit 20. Specific configuration and operation of the reservation server 30 are described in detail later.

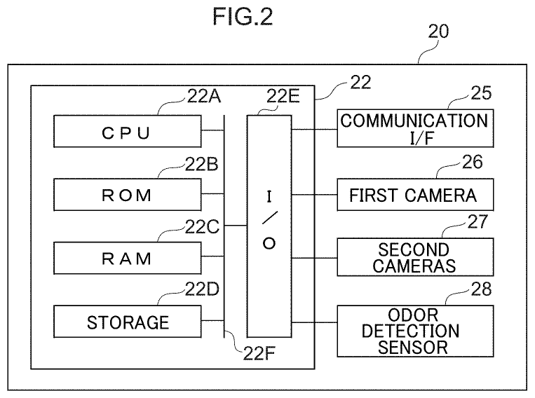

FIG. 2 is a block diagram illustrating a hardware configuration of the onboard units 20.

As illustrated in FIG. 2, each of the onboard units 20 includes a control device 22. The control device 22 includes a central processing unit (CPU) 22A, read only memory (ROM) 22B, random access memory (RAM) 22C, storage 22D, and an input/output interface (I/O) 22E. These configuration sections are connected together so as to be capable of communicating with each other through a bus 22F.

A communication interface (communication I/F) 25, a first camera 26, a second camera 27, and an odor detection sensor 28 are connected to the I/O 22E. The communication I/F 25 is an interface enabling the onboard unit 20 to communicate with the reservation server 30 and other devices, and employs a protocol such as Ethernet (registered trademark), FDDI, or Wi-Fi (registered trademark).

The first camera 26 and the second camera 27 are each configured including, for example, a CCD image sensor, a CMOS image sensor, a MOS image sensor, or the like. As an example, the first camera 26 is provided at a roof inside the cabin of the corresponding vehicle 12 so as to be capable of imaging the appearance of the interior of the vehicle 12. As an example, plural of the second cameras 27 are provided at outer surfaces of the vehicle 12 so as to be capable of imaging the appearance of the exterior of the vehicle 12. The odor detection sensor 28 is provided inside the cabin of the vehicle 12 so as to detect the odor strength (the odor level) inside the cabin of the vehicle 12. As an example, in the present exemplary embodiment the strength of the odor detected by the odor detection sensor 28 is ranked into six grades from 0 to 5, with 0 indicating a very low level of the odor, and 5 indicating a very high level of the odor.

The CPU 22A of the control device 22 is a central processing unit that executes various programs and controls various sections. Namely, the CPU 22A reads a program from the ROM 22B or the storage 22D, and executes this program using the RAM 22C as a workspace. The CPU 22A controls the above-described configurations and performs various computation processing according to the program recorded in the ROM 22B or the storage 22D.

The ROM 22B holds various programs and various data. An information transmission program and vehicle ID data, this being information used to identify the individual vehicle 12, are held in the ROM 22B. The information transmission program transmits to the reservation server 30 information relating to the respective images captured by the first camera 26 and the second cameras 27, and information relating to the odor strength inside the cabin as detected by the odor detection sensor 28.

The RAM 22C serves as a workspace to temporarily store programs or data. The storage 22D is configured by a hard disk drive (HDD) or a solid state drive (SSD), and holds various programs including an operating system, as well as various data. Note that one or both of the information transmission program and the vehicle ID data mentioned above may be held in the storage 22D instead of the ROM 22B.

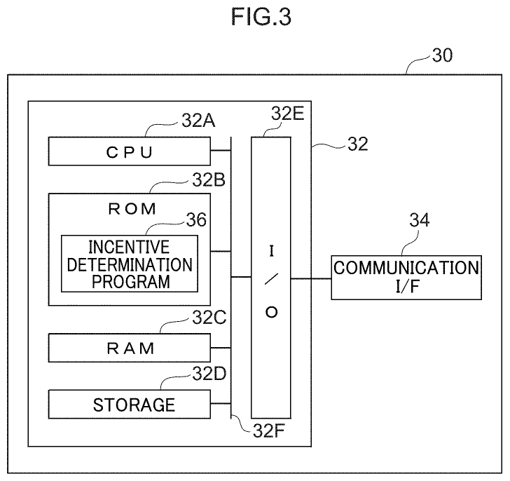

FIG. 3 is a block diagram illustrating a hardware configuration of the reservation server 30, serving as a computer.

As illustrated in FIG. 3, the reservation server 30 includes a control section 32 including a CPU 32A, ROM 32B, RAM 32C, storage 32D, and an input/output interface (I/O) 32E. These configuration sections of the control section 32 are connected together so as to be capable of communicating with each other through a bus 32F.

A communication interface (communication I/F) 34 is connected to the I/O 32E. The communication I/F 34 is an interface enabling the reservation server 30 to communicate with other devices such as the onboard units 20 and the user terminal 40, and employs a protocol such as Ethernet (registered trademark), FDDI, or Wi-Fi (registered trademark).

The CPU 32A of the control section 32 is a central processing unit that executes various programs and controls various sections. Namely, the CPU 32A reads a program from the ROM 32B or the storage 32D, and executes this program using the RAM 32C as a workspace. The CPU 32A controls the above-described configurations and performs various computation processing according to the program recorded in the ROM 32B or the storage 32D.

The ROM 32B holds various programs and various data. In the present exemplary embodiment, an incentive determination program 36 and a presentation program (not illustrated in the drawings) are held in the ROM 32B. The incentive determination program 36 determines incentives offered when renting out the vehicles 12, based on information received from the corresponding onboard units 20. The presentation program presents information, including information regarding such incentives, to the user terminal 40.

The RAM 32C serves as a workspace to temporarily store programs or data. The storage 32D is configured by an HDD or an SSD, and holds various programs including an operating system, as well as various data.

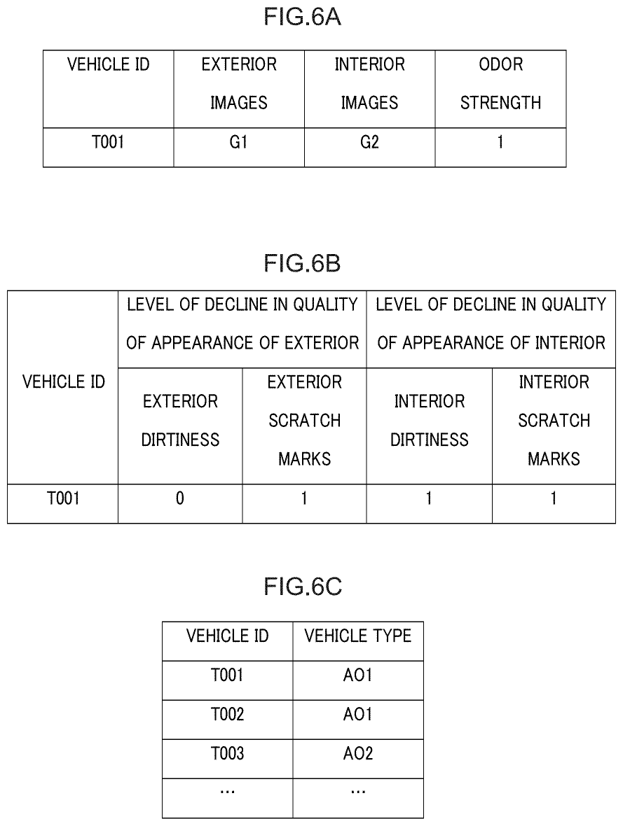

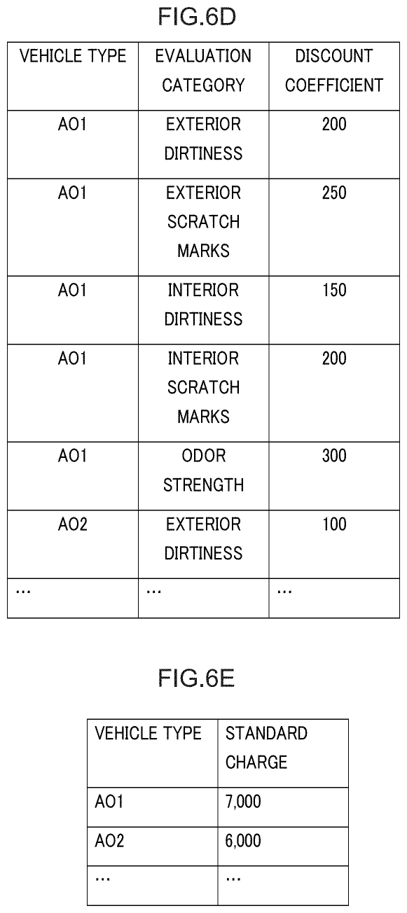

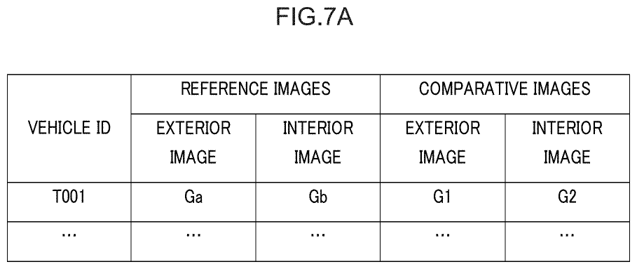

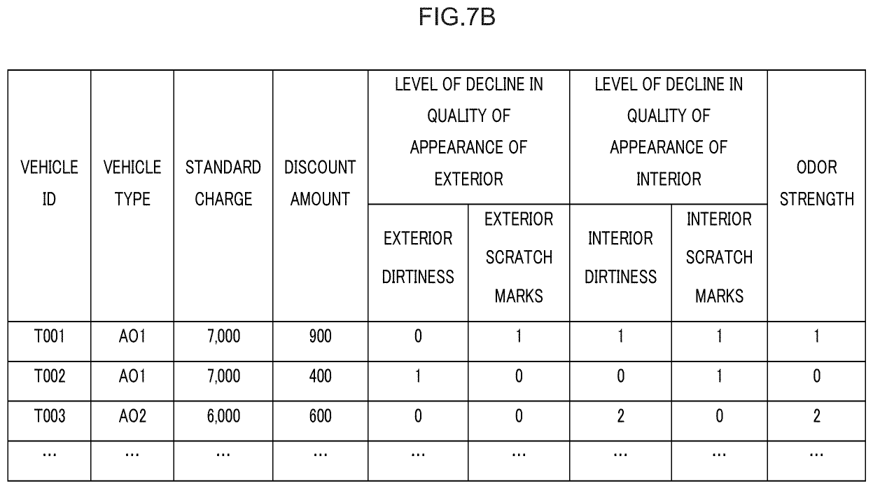

As an example, in the present exemplary embodiment an image data table (see FIG. 7A), a discount data table (see FIG. 7B), a reservation data table (not illustrated in the drawings), and various reference tables are held in the storage 32D. Note that examples of reference tables include a vehicle type table (see FIG. 6C), a discount coefficient table (see FIG. 6D), and a standard charge table (see FIG. 6E). The image data table that is schematically illustrated in FIG. 7A is a table in which the vehicle ID and interior and exterior images of the corresponding vehicle 12 are associated with each other. In the image data table, reference images represent vehicle images used for reference, and comparative images represent images of the vehicle 12 in a state prior to rental (images that are updated each time the vehicle 12 is returned). Note that for simplicity, the image data is denoted Ga, Gb, G1, and G2 in FIG. 7A. The discount data table schematically illustrated in FIG. 7B is a table in which discount-related information is saved for each vehicle ID.

Note that the incentive determination program 36 illustrated in FIG. 3 and presentation program (not illustrated in the drawings) mentioned above may be held in the storage 32D instead of the ROM 32B.

When the incentive determination program 36 and the presentation program are executed, the reservation server 30 employs the above-described hardware resources to implement various functions. Next, explanation follows regarding functional configuration implemented by the reservation server 30.

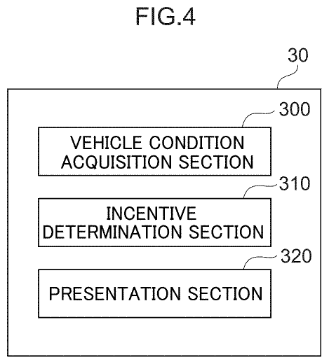

FIG. 4 is a block diagram illustrating an example of functional configuration of the reservation server 30.

As illustrated in FIG. 4, the reservation server 30 includes a vehicle condition acquisition section 300, an incentive determination section 310, and a presentation section 320 as functional configuration. The vehicle condition acquisition section 300 and the incentive determination section 310 are implemented by the CPU 32A reading and executing the incentive determination program 36 stored in the ROM 32B. The presentation section 320 is implemented by the CPU 32A reading and executing the presentation program stored in the ROM 32B.

The vehicle condition acquisition section 300 acquires information relating to both the level of decline in the quality of appearance of each of the vehicles 12 and the level of decline in the cleanliness inside the cabin of the vehicle 12. As an example, in the present exemplary embodiment the information relating to the level of decline in cleanliness inside the cabin refers to the information relating to the odor level inside the cabin. The vehicle condition acquisition section 300 computes and acquires the level of decline in the quality of appearance of each of the vehicles 12 in a state prior to rental by comparing the reference images, these being vehicle images that are used against the comparative images, these being images of the vehicle 12 in a state prior to rental. Note that as an example, the reference images represent the exact same vehicle as the vehicle in the comparative images dating from when the vehicle was brand new, or are images of a brand new vehicle of the same type and the same color as the vehicle in the comparative images. The level of decline in the quality of appearance and the odor level, these being the information acquired by the vehicle condition acquisition section 300, are each ranked into six grades from 0 to 5, with 0 indicating a very low level of the decline, and 5 indicating a very high level of the decline.

Based on the information acquired by the vehicle condition acquisition section 300, the incentive determination section 310 determines incentives according to these levels. To explain this more specifically, the incentive determination section 310 determines incentives such that as these levels for the vehicle 12 get higher a greater benefit is conferred on the user who rents the vehicle 12.

The presentation section 320 presents the incentives offered for the rental vehicles 12. The presentation section 320 also presents both the level of decline in the quality of appearance of the respective vehicles 12 and the odor level inside the cabins of the respective vehicles 12, acquired by the vehicle condition acquisition section 300.

Next, explanation follows regarding operation of the vehicle rental assist system 10.

First, explanation follows regarding a flow of processing by the onboard unit 20 illustrated in FIG. 2. The onboard unit 20 starts execution of information transmission processing when the first camera 26 has imaged the appearance of the interior of the vehicle 12, the second cameras 27 have imaged the appearance of the exterior of the vehicle 12, and the odor detection sensor 28 has detected the odor strength inside the cabin of the vehicle 12. Note that operations by the first camera 26, the second cameras 27, and the odor detection sensor 28 are executed prior to the vehicle 12 being first rented out, and each time the vehicle 12 is returned.

The information transmission processing executed by the onboard unit 20 is performed by the CPU 22A reading the information transmission program from the ROM 22B, and expanding and executing the information transmission program in the RAM 22C. In this information transmission processing, information regarding the images respectively captured by the first camera 26 and the second cameras 27, information regarding the odor strength detected by the odor detection sensor 28, and the vehicle ID of the vehicle 12 in question are associated with each other and transmitted to the reservation server 30 illustrated in FIG. 3.

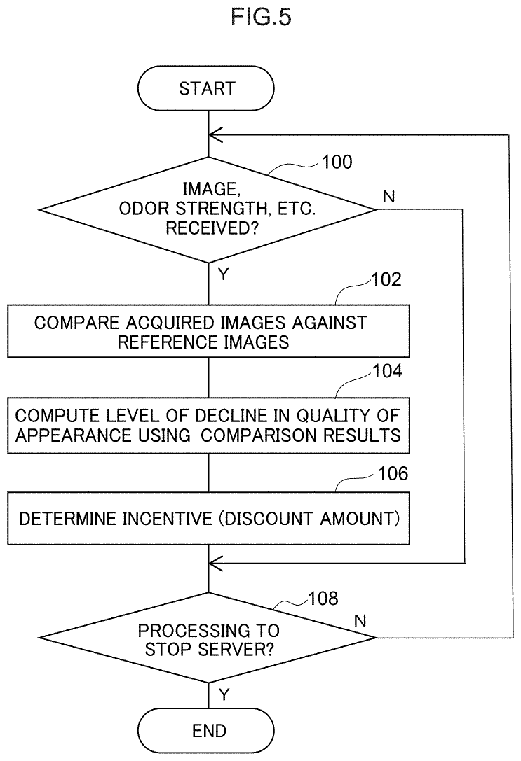

Next, explanation follows regarding incentive determination processing by the reservation server 30. FIG. 5 is a flowchart illustrating an example of a flow of the incentive determination processing performed by the reservation server 30. The incentive determination processing is performed by the CPU 32A reading the incentive determination program 36 from the ROM 32B and expanding and executing the incentive determination program 36 in the RAM 32C when the reservation server 30 is activated. Note that it is assumed that the reference images, these being images used as references for the vehicles, have already been acquired for each of the vehicles 12 at the vehicle condition acquisition section 300 before the incentive determination illustrated in FIG. 5 is processed.

First, at step 100 in FIG. 5, the CPU 32A determines whether or not captured image information, odor strength information, and the vehicle ID transmitted from a corresponding onboard unit 20 have been received (in other words, whether or not these have been acquired). Note that the captured images of the vehicle 12 are captured by the first camera 26 and the second cameras 27, the odor strength is the odor level inside the cabin of the vehicle 12 as detected by the odor detection sensor 28, and the vehicle ID corresponds the vehicle 12 in question. The odor strength information corresponds to information relating to the level of decline in cleanliness.

In cases in which the captured image information and so on have not been received (step 100: N), the CPU 32A transitions to the processing of step 108 (described later). In cases in which the captured image information and so on has been received (step 100: Y), the CPU 32A acquires the vehicle ID, exterior images, interior image, and odor strength as illustrated in FIG. 6A. Note that for simplicity, exterior image data is denoted G1 and interior image data is denoted G2 in FIG. 6A.

At step 102, the CPU 32A compares the images (comparative images) acquired at step 100 against the reference images. Next, at step 104, the CPU 32A uses the results of the comparison of step 102 to compute the level of decline in the quality of appearance of the vehicle. The CPU 32A is therefore able to acquire precise information regarding the level of decline in the quality of appearance of the vehicle 12.

FIG. 6B illustrates an example of computation results of the level of decline in the quality of appearance of the corresponding vehicle 12 (the extent of decline in the quality of appearance). As an example, the level of decline in the quality of appearance is computed for four categories, these being “exterior dirtiness”, “exterior scratch marks”, “interior dirtiness”, and “interior scratch marks”. The categories “exterior dirtiness” and “interior dirtiness” determine the level of decline in the quality of appearance from the perspective of how dirty the vehicle looks (including a dirty appearance caused by deterioration of the paintwork). The categories “exterior scratch marks” and “interior scratch marks” determine the level of decline in the quality of appearance from the perspective of the extent of scratch marks.

Next, at step 106, the CPU 32A determines an incentive according to the level of decline in the quality of appearance of the vehicle 12 and the odor level (broadly speaking, the decline in cleanliness) inside the cabin of the vehicle 12. To explain this more specifically, the CPU 32A determines incentives such that as the level of decline in the quality of appearance of the vehicle 12 gets higher a greater benefit is conferred on the user who rents this vehicle 12, and also such that as the odor level (odor strength) inside the cabin gets higher a greater benefit is conferred on the user who rents this vehicle 12. This enables the needs of a user who desires such incentives conferred according to the condition of the vehicle 12 prior to rental to be met. Some users want to rent at low cost and are not concerned about whether the vehicle is dirty.

Explanation follows regarding an example of a method of determining the discount amount, with reference to FIG. 6A to FIG. 6D. FIG. 6C illustrates an example of a table indicating the vehicle type of each vehicle, and FIG. 6D illustrates an example of a table indicating discount coefficients for each evaluation category according to vehicle type. The CPU 32A identifies the vehicle type with the vehicle ID “T001” in FIG. 6A and FIG. 6B by referring to the vehicle type table illustrated in FIG. 6C, and identifies the discount coefficients for the identified vehicle type by referring to the discount coefficient table illustrated in FIG. 6D. Next, the CPU 32A computes the discount amount by multiplying the respective values for the odor strength illustrated in FIG. 6A and the extent of the decline in the quality of appearance illustrated in FIG. 6B by the corresponding discount coefficients illustrated in FIG. 6D, and adding these multiplication results together.

Returning to FIG. 5, next, at step 108, the CPU 32A determines whether or not processing to stop the reservation server 30 is being executed. In cases in which processing to stop the reservation server 30 is not being executed (step 108: N), the CPU 32A repeats the processing from step 100. In cases in which processing to stop the reservation server 30 is being executed (step 108: Y), the CPU 32A ends the processing based on the incentive determination program 36.

Next, explanation follows regarding presentation processing performed by the reservation server 30. On receiving information regarding a search processing request from the user terminal 40, the reservation server 30 executes a presentation processing routine. The presentation processing routine is performed by the CPU 32A reading the presentation program from the ROM 32B and expanding and executing the presentation program in the RAM 32C.

During the presentation processing routine, first, the CPU 32A uses a database to generate information satisfying search conditions. The generated information includes standard vehicle rental charges, incentive information (discount amounts), information regarding the level of decline in the quality of appearance of each of the vehicles 12, and information regarding the odor level inside the cabin of each of the vehicles 12. Next, the CPU 32A transmits the generated information to the user terminal 40 that submitted the search processing request, and ends the presentation processing routine.

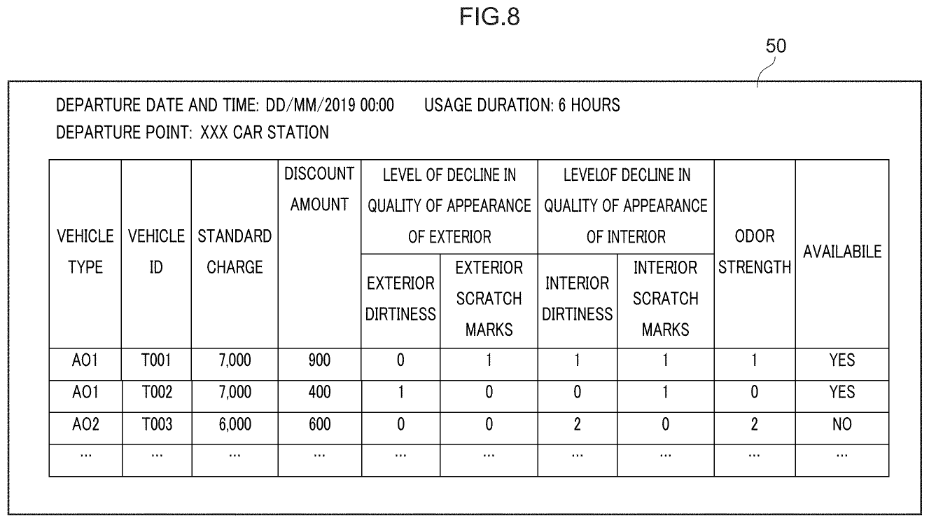

Search results such as those illustrated in FIG. 8 are displayed on the user terminal 40. Thus, a user wishing to rent a vehicle 12 is able to ascertain from the user terminal 40 what incentives are available, as well as the reasons for these incentives. Note that in FIG. 8, a departure date and time, a departure point, and so on that have been input using the user terminal 40 are displayed in an upper part of a screen 50. Availability is displayed in the column on the furthest right of the search result table.

As explained above, the present exemplary embodiment is capable of meeting the needs of a user who desires an incentive conferred as a result of the condition of the vehicle 12 prior to rental.

Note that as a modified example of the above exemplary embodiment, incentives may take the form of points conferred as part of a loyalty program (a service in which points conferred on a customer can be used as part of a subsequent payment).

As a modified example of the above exemplary embodiment, a camera that images the appearance of the exterior of the vehicle 12 may be a camera other than the second cameras 27 of the onboard unit 20, such as a camera installed at a car station, or a camera mounted to a drone. Alternatively, imaging of the appearance of the vehicle 12 may be performed manually. Information regarding exterior and interior scratch marks may also be input manually.

As a modified example of the above exemplary embodiment, the vehicle condition acquisition section may for example acquire information relating to the level of decline in the quality of appearance of a vehicle, which information has been computed by the onboard unit or the like. As another modified example, the vehicle condition acquisition section may for example compute and acquire the level of decline in the quality of appearance of a vehicle based on the result of measuring the appearance of the vehicle using color sensors.

As a modified example of the above exemplary embodiment, the vehicle condition acquisition section may acquire information relating to one of the level of decline in the quality of appearance or the level of decline in cleanliness (such as the odor) inside the cabin of the vehicle. As another modified example of the above exemplary embodiment, the level of decline in the quality of appearance of a vehicle may be the level of decline in the quality of appearance of either one of the interior or the exterior of the vehicle.

Although information relating to the odor level is employed as information relating to the level of decline in cleanliness in the above exemplary embodiment, there is no limitation thereto. Namely, the information relating to the level of decline in cleanliness may, for example, be information relating to the amount of bacteria (or bacteria and viruses) present in a predetermined range inside the cabin of a vehicle, or may be such information relating to the amount of bacteria (or bacteria and viruses) in addition to information relating to the odor level. To explain further, an onboard unit 20 may be provided with a detection sensor that detects bacteria (or bacteria and viruses) in a predetermined range inside the cabin of a vehicle 12, and an onboard unit 20 may include a function to transmit the detection result thereof to a reservation server 30. In such cases, the incentive determination section determines an incentive reflecting the amount of bacteria (or bacteria and viruses).

As a modified example of the above exemplary embodiment, in cases in which the odor strength is anything other than 0 and this odor is a predetermined odor typical of vehicles, the incentive determination section may, for example, determine an incentive such that the benefit conferred on the user is smaller than in the case of other odors.

As a modified example of the above exemplary embodiment, a configuration may be adopted in which the presentation section does not present the level of decline in the quality of appearance of a vehicle and the level of decline in cleanliness (such as the odor) inside the cabin of the vehicle on the user terminal. In such cases, the presentation section presents a comfort level evaluation of the overall vehicle condition based on the level of decline in the quality of appearance of the vehicle and the level of decline in cleanliness (such as the odor) inside the cabin in the form of numerical values or symbols on the user terminal.

Although the reference images are images of a vehicle when brand new in the above exemplary embodiment, for example in cases in which standard charges are set on the assumption that the vehicle will be a used vehicle of a predetermined age, images of a used vehicle of a predetermined age may be used as the reference images.

The information transmission processing, the incentive determination processing, and the presentation processing executed by the CPUs 22A, 32A reading and executing software (a program) in the above exemplary embodiment may be executed by various types of processor other than a CPU. Such processors include programmable logic devices (PLD) that allow circuit configuration to be modified post-manufacture, such as a field-programmable gate array (FPGA), and dedicated electric circuits, these being processors including a circuit configuration custom-designed to execute specific processing, such as an application specific integrated circuit (ASIC). The information transmission processing, the incentive determination processing, and the presentation processing may be executed by any one of these various types of processor, or by a combination of two or more of the same type or different types of processor (such as plural FPGAs, or a combination of a CPU and an FPGA). The hardware structure of these various types of processors is more specifically an electric circuit combining circuit elements such as semiconductor elements.

In the above exemplary embodiment and modified examples within the above exemplary embodiment, the information transmission program is pre-stored (installed) in the ROM 22B or the storage 22D, and the incentive determination program 36 and the presentation program are pre-stored (installed) in the ROM 32B or the storage 32D. However, there is no limitation thereto. The programs may be provided in a format recorded on a recording medium such as compact disc read only memory (CD-ROM), digital versatile disc read only memory (DVD-ROM), or universal serial bus (USB) memory. Alternatively, the programs may be provided in a format downloadable from an external device through a network.

Note that the above-described exemplary embodiment and modified examples may be implemented in appropriate combinations.

Although examples of the present disclosure have been described above, the present disclosure is not limited to the above description, and obviously various other modifications may be implemented within a range not departing from the scope of the present disclosure.

What is claimed is:

1. A vehicle rental assistance device comprising a memory and a processer connected to the memory, and the processor being configured to:
acquire vehicle condition information relating to at least one level of a level of decline in quality of appearance of a vehicle or a level of decline in cleanliness inside a cabin of the vehicle; and
determine an incentive for vehicle rental according to the at least one level, based on the acquired vehicle condition information.

2. The vehicle rental assistance device of claim 1, wherein the vehicle condition information relating to the level of decline in cleanliness includes information relating to an odor level.

3. The vehicle rental assistance device of claim 1, wherein the processer determines the incentive based on the acquired vehicle condition information such that, as the at least one level for a vehicle gets higher, a greater benefit is conferred on a user who rents the vehicle.

4. The vehicle rental assistance device of claim 1, wherein:
the processer computes and acquires the level of decline in the quality of appearance of each vehicle at a state prior to rental by comparing a reference image of a vehicle against a comparative image of the vehicle in the state prior to rental.

5. The vehicle rental assistance device of claim 1, the processer is further configured to present the incentive offered with respect to a vehicle for rental.

6. The vehicle rental assistance device of claim 5, wherein the processer is further configured to present the at least one level representing the acquired vehicle condition information.

7. An incentive determination method for vehicle rental, the method being executed by a computer and comprising:
acquiring vehicle condition information relating to at least one level of a level of decline in quality of appearance of a vehicle or a level of decline in cleanliness inside a cabin of the vehicle; and
determining an incentive according to the at least one level, based on the acquired vehicle condition information.

8. A non-transitory recording medium storing an incentive determination program executable by a computer to perform processing, the processing comprising;
acquiring vehicle condition information relating to at least one level of a level of decline in quality of appearance of a vehicle or a level of decline in cleanliness inside a cabin of the vehicle; and
determining an incentive according to the at least one level, based on the acquired vehicle condition information.
